(19) United States
(12) Patent Application Publication
(10) Pub. No.: US 2006/0112152 A1
(43) Pub. Date: May 25, 2006

(54) Smart patching by targeting particular prior versions of a file

(75) Inventors: Carolyn L. Napier, Seattle, WA (US); Rahul Thombre, Seattle, WA (US); Christopher S. Gouge, Redmond, WA (US); David E. Kays, Bellevue, WA (US)

Correspondence Address: SENNIGER POWERS, ONE METROPOLITAN SQUARE, 16TH FLOOR, ST. LOUIS, MO, 63102, US

(73) Assignee: Microsoft Corporation, Redmond, WA (US)

(21) Appl. No.: 10/994,880

(22) Filed: Nov. 22, 2004

(51) Int. Cl. G06F 12/00; G06F 17/30

(52) U.S. Cl. 707/203

(57) ABSTRACT

Limiting patch size and complexity through heuristics which use file and product attributes to select a subset of reference file versions (prior states) from the set of all file versions. Patches target this set of reference versions. The computing device stores one or more of the prior states. The current state of the file represents at least one of the prior states with an update applied thereto. The invention selects one of the updates from the patch that corresponds to one of the prior states stored on the computing device. The invention applies the selected update to the corresponding prior state to update the file.

### TECHNICAL FIELD

Embodiments of the present invention relate to the field of updating software application programs on a computing device. In particular, embodiments of this invention relate to provide faster and more efficient updates by applying a patch to a reference state of a file cached on the computing device to update a current version of a file.

### BACKGROUND OF THE INVENTION

Changes, including updates, to a software application program due to bug fixes, required functionality, and the like are inevitable. For example, discovered security vulnerabilities in an application require immediate attention, with an update package distributed as quickly as possible. Even for users connected to the web via high-speed network connections and especially for those users with low bandwidth connections, update package download size is of critical importance. Currently, software vendors that wish to distribute updates to their applications either issue an entirely new application installation image or issue update packages. Common problems faced by vendors include distribution of updates that are too large for download, too difficult or time-consuming to create, or require access to the original install media when applied. For example, in some systems, laptop users have to be connected to the network to install some of the patches.

Further, with the ever-increasing frequency of software product updates and the continually improving ease of patch distributions and applications, a variety of prior patches may or may not have been previously applied to a particular user's computer or other computing device. Given the number of updates distributed for the application, users may be at different product plus update configuration states. Prior systems experience great difficulty in updating all these product and patch configurations. For example, if a software vendor has already released four patches for a particular product, a user's computer may have none, some, or all of the previously released patches when an installation application is applying a fifth patch to the user's computer. As such, software vendors increasingly find it difficult to correctly update a software application using patches.

Some previous systems use a patch server in combination with file compression technology to minimize download bandwidth. An update process searches the user's computer for possible file targets, which are then sent to the patch server to determine the most optimized payload for the update (e.g., to provide a dynamic payload customized to the user's computer). However, the requirements for maintaining this configuration are too much for the typical software vendor. Most software vendors do not have the infrastructure to maintain numerous reference files or manage large patch servers. Further, this previous method requires the user to be connected to a network during the patching operation because there is a need for communication with a patch server.

Accordingly, a system for targeting a patch to a selected prior version of the file to update a current version of the file is desired to address one or more of these and other disadvantages.

### SUMMARY OF THE INVENTION

Embodiments of the invention enable application vendors to distribute smaller and more reliable changes, including updates, for their applications. In an embodiment, the invention distributes application updates optimized for both size and speed without requiring access to the original installation media. On a user's computing device, the invention receives a patch having one or more updates for a file. The patch only includes updates targeted to certain prior versions (e.g., baselines) of the file. As such, the patch size is reduced. The file to be updated has a current state representing a reference state (e.g., a prior version) with at least one update applied thereto. The invention identifies the reference state from the current state and selects one of the one or more of the updates from the patch as a function of the identified reference state. The selected update corresponds to the identified reference state. The invention applies the selected update to the identified reference state to update the file.

In one embodiment, an update includes compressed binary data representing a difference or delta between a prior version of the file (e.g., a reference file) and the desired, updated file. The compression produces an even greater reduction in update package size and thereby a reduction in the bandwidth required to download the update package. With the reference file available on the target computer, the invention synthesizes the desired, updated file to apply the update.

The invention enables simple and fast creation, maintenance, and application of updates. The updates may be applied without access to the original installation source. Further, the updates install reliably and correctly regardless of which updates have already been applied to the file. In one embodiment, a copy-on-write cache stores a copy of all files affected by an update. The copy-on-write cache also enables the rollback of any applied updates and allows application of updates without requiring access to the original source media.

The invention also simplifies the creation of patches since the patches only need to target specific reference states of the file rather than all prior states of the file.

According to one aspect of the invention, a method applies a patch to a file on a computing device. The method includes receiving a patch with one or more file changes. The method also includes determining, from the received patch, a file on a computing device to be changed by the received patch. The method also includes identifying a current state of the determined file on the computing device. The identified current state represents a reference state with at least one other file change applied thereto. The method also includes identifying the reference state of the file from the identified current state and selecting one of the one or more file changes from the received patch as a function of the identified reference state. The selected file change corresponds to the identified reference state. The method also includes applying the selected file change to the identified reference state to change the file.

According to another aspect of the invention, a method applies a patch to a file on a computing device. The patch includes one or more updates to the file. The method includes storing a current version of the file and a plurality of prior versions of the file. The plurality of prior versions has a logical order relative to each other and to the current version. Each of the one or more updates corresponds to one of the stored prior versions of the file. The method also includes identifying, as a function of the logical order of the plurality of prior versions, one of the stored prior versions of the file to be updated. The method also includes selecting one of the updates to apply to the file. The selected one of the updates corresponds to the identified prior version. The method also includes applying the selected update to the identified prior version of the file.

According to still another aspect of the invention, a method provides a patch to create a new version of a file. The method includes defining a file to have a plurality of primary versions and one or more secondary versions. The method also includes identifying each of the plurality of primary versions. The method also includes generating a plurality of updates. Applying each of the generated plurality of updates to each of the identified primary versions results in a new version of the file. The method also includes aggregating the generated updates to create a patch for the file and providing the created patch to an end user.

According to yet another aspect of the invention, one or more computer-readable media have computer-executable components for applying a patch to a file on a computing device. The components include a sequencing engine for receiving a patch. The patch has one or more file changes. The components also include a resource update evaluation engine for determining, from the received patch, a file on a computing device to be changed by the received patch. The resource update evaluation engine further identifies a current state of the determined file on the computing device. The identified current state represents a reference state with at least one other file change applied thereto. The resource update evaluation engine further identifies the reference state of the file from the identified current state. The components also include a payload engine for selecting one of the one or more file changes from the received patch as a function of the identified reference state. The selected file change corresponds to the identified reference state. The components also include a patch engine for applying the selected file change to the identified reference state to change the file.

According to another aspect of the invention, a system applies a patch. The system includes a memory area storing a current state of a file and a reference state of the file having file changes applied thereto. The memory area further stores a patch. The patch includes one or more file changes. The system also includes a processor that is configured to execute computer-executable instructions for determining, from the patch stored in the memory area, the file to be changed by the patch stored in the memory area, selecting one of the one or more patch changes from the stored patch as a function of the reference state stored in the memory area, and applying the selected patch change to the stored reference state to change the file. The selected patch change corresponds to the reference state stored in the memory area.

Alternatively, the invention may comprise various other methods and apparatuses.

Other features will be in part apparent and in part pointed out hereinafter.

### BRIEF DESCRIPTION OF THE DRAWINGS

FIG. 1A-FIG. 1C are exemplary block diagrams illustrating the relationship between a current state of a file and a reference state of the file.

FIG. 2 is an exemplary flow chart illustrating operation of an embodiment of the invention.

FIG. 3 is an exemplary block diagram illustrating new file synthesis starting at a released-to-manufacturing version of a file.

FIG. 4 is an exemplary flow chart illustrating an exemplary patching process.

FIG. 5 is a block diagram illustrating an exemplary environment in which embodiments of the present invention may be utilized.

FIG. 6A and FIG. 6B are block diagrams illustrating binary delta compression technology.

FIG. 7 is a block diagram illustrating one example of a suitable computing system environment in which the invention may be implemented.

Corresponding reference characters indicate corresponding parts throughout the drawings.

### DETAILED DESCRIPTION OF THE INVENTION

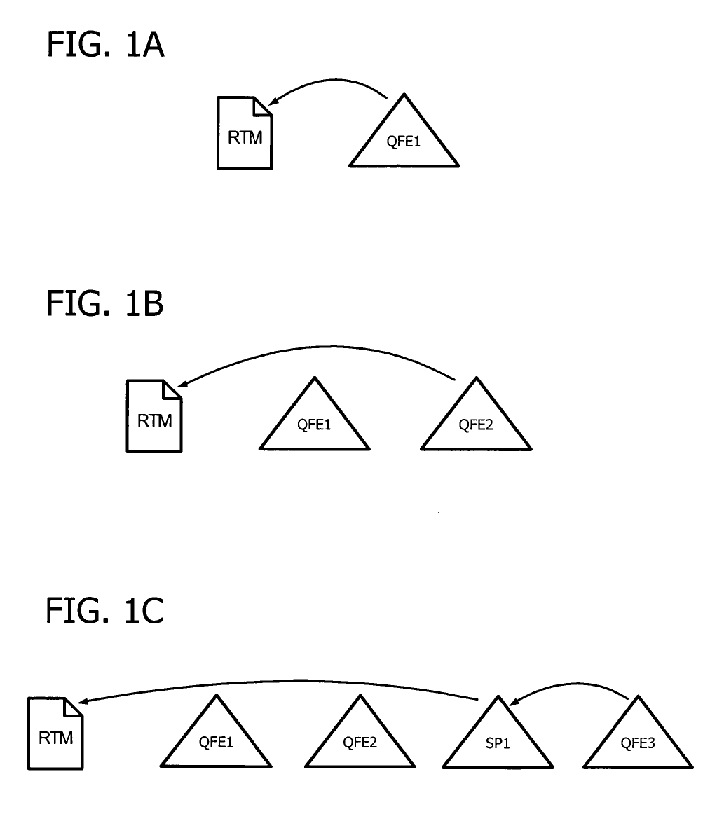

In an embodiment, the invention includes a patching solution. In particular, the invention enables application vendors to easily create small and reliable changes, including updates, with static payloads that do not require access to the original installation media when applied to a computing device and are applicable to all previous product plus update configuration states. As shown in FIGS. 1A-1C, while application vendors have the ability to distribute small updates (e.g., a quick fix engineering update—QFE), they will at times roll up many updates or significant updates into a minor update (e.g., a service pack (SP)) as a single update. An update to an application with a sufficient number of changes that warrants a version change of the application is deemed by the application vendor to be a checkpoint version or a baseline version of the application. The versions of the files that encompass the application checkpoint version represent the baseline versions of those files. The baseline methodology applies at either the application or file level. Alternatively, the application vendor may choose to deem a particular file version as a baseline version because it represents a known, good state for the file. One or more of the baseline versions are cached on the user's computer. In one embodiment of the invention, the application vendors tailor a patch to only include one or more updates each corresponding to at least one of these baseline versions of the file to simplify and improve the efficiency of the servicing model. Application of each of the updates to the corresponding baseline versions results in creation of the updated application or file.

In FIG. 1C, the baseline versions include the RTM version and SP1. From a patching perspective, the various QFEs at a minimum use the most recent baseline version (e.g., the baseline version resulting from applying the last patch in a logical order of patches) as a reference state to which a patch may be selected and applied according to the invention. When creating patches, application vendors need only concern themselves with already identified baselines. The number of baselines to target is left to the vendor and can be determined by their own set of criteria. Further, the progression of the software product from one version to the next version and the explicit intent of a patch author or application vendor define a logical order of the patches. The logical order may be relative to the other versions and/or to a current version. And the logical order of the patches is not necessarily influenced by the order in which the target machine encounters the patches or the installation time of the patches on the target machine. Correspondingly, the baseline versions are logically ordered according to the logical ordering of the patches.

As such, application vendors only target baselines of the application or file when building the payload for a patch. By only targeting baseline application versions, application vendors eliminate the burden of managing large collections of reference files and reference versions of files, as well as the burden of creating and testing patches that correctly target large numbers of reference versions of the files. The application vendors (e.g., via their patch installation programs) need only maintain one or more baseline versions of the files on the user's computer. In one embodiment, only the two most recent baselines are cached on the user's computer. Another embodiment of the invention caches a different number of different sets of baselines on the user's computer. The application vendors declare whether a patch includes a new baseline version of a file or represents a baseline version of the application (denoted as a minor update). Further, the application vendors may declare the product that is updated by the patch, the relative order of the patch with respect to other patches, the targeted files of the patch, and the patch payload file updates, for example, in metadata associated with the patch.

Another embodiment of the inventions allows for the possibility of creating updates that only target the released-to-manufacturing (RTM) version of the product or files. The application vendors may indicate this via additional metadata added to the patch. An installer engine looking at this metadata uses this knowledge to synthesize the desired versions of the file directly from the RTM version of the file instead of using subsequently released baselines.

An embodiment of the invention includes defining a file to have a plurality of primary versions and one or more secondary versions. The invention identifies each of the plurality of primary versions and generates a plurality of updates corresponding thereto. That is, each of the generated plurality of updates applies to each of the identified primary versions. The actual application of each of the generated plurality of updates to the corresponding primary version results in the same new version of the file. The invention further includes aggregating the generated updates to create a patch for the file and providing the created patch to an end user.

Caching the Baseline Versions

The invention maintains a per-product cache on each user machine. In one embodiment, the baseline cache provides full-file (e.g., the entire copy of the file) baselines for files that have been updated by patches. The cache includes the originally installed file versions and, in one example, may include one or more recent baseline versions (e.g., the last service pack version of the file in a logical order of versions). The cache helps to reduce the need to access the original installation media. The cache is maintained in a copy-on-write manner such that a file is only added to the cache when it is updated by a patch. In one embodiment, the invention devotes ten percent of total disk space to the cache. Further, the caching behavior may be controllable via policy. Alternative embodiments of the invention may cache a full-file version of the file for some baselines and store other baselines in the form of binary-delta information which can generate the baseline from another cached baseline stored as binary-delta or full-file. Yet another embodiment of the invention may cache some baselines in the form of binary-delta information based on the current machine state.

In one embodiment, the cache is organized as a directory structure organized according to product boundaries. The cache stores full-file versions of the product files. For example, there may be a subdirectory for each baseline (e.g., product version). The author of the patch specifies the baselines. An identity embedded with or otherwise associated with the patch indicates the baseline.

With one or more of the baselines stored on the user's computer, the invention processes the update payload to synthesize the new file correctly without requiring the original installation media because the needed baseline versions are already available in the cache on the user's computer.

Applying the Patch

Referring again to FIG. 1A, a block diagram illustrates a released to manufacturing (RTM) version of a file along with one update (e.g., QFE1) to the file. As such, the current state of file is RTM+QFE1, while the reference state is RTM. Possible reference states are baseline versions of the file. The initial version of the file, also called the RTM file version, is always a baseline. The patch author identifies further file baseline versions. In an embodiment of the invention, a patch author denotes a baseline version by indicating that the patch is a minor update or service pack (SP) in the patch's metadata. Patch authors denote non-baseline versions by indicating that the patch is a small update or quick-fix engineering (QFE) in the patch's metadata. In FIG. 1B, while another small update (e.g., QFE2) has been applied to the current state shown in FIG. 1A, the reference state is still RTM. In FIG. 1C, a service pack (e.g., SP1) has been applied to the current state shown in FIG. 1B. In addition, the application of a small update (e.g., QFE3) to the SP1 version results in a current version of SP1+QFE3. If the SP1 version of the file is present, the QFE3 file is synthesized using SP1+QFE3. In this example, the reference state is SP1.

However, the RTM version of the file may also serve as a reference state if necessary (e.g., the SP1 version of the file was deleted) or if the patch author so chooses. That is, with or without directly specifying the RTM version as a reference state, the RTM version is available for synthesizing the new file (e.g., QFE3). In this example, given that the reference state of SP1 is RTM, the QFE3 file in FIG. 1C may be synthesized by starting with RTM and then applying the SP1 delta and then the QFE3 delta (e.g., RTM+SP1+QFE3).

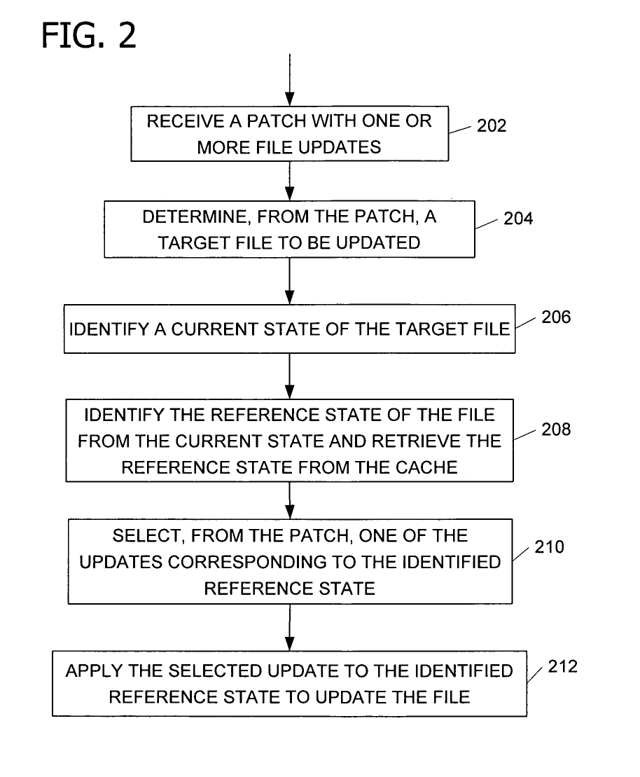

Referring next to FIG. 2, a flow chart illustrates exemplary operation of an embodiment of the invention in which a patch is applied to a file accessible by a computing device. The invention receives a patch at 202 having one or more file changes. From the patch information (e.g., in a header), the invention determines at 204 which file(s) are the target of the patch. The invention identifies a current state of the file at 206. The current state represents a reference state with at least one other file change applied thereto. The invention identifies the reference state of the file at 208 from the identified current state and retrieves the identified reference state from a cache or other memory area accessible by the computing device. The invention selects at least one of the file changes at 210 from the received patch as a function of the identified reference state. The selected file change corresponds to the identified reference state. The invention applies the selected file change at 212 to the identified reference state to change the file. In one embodiment, one or more computer-readable media have computer-executable instructions for performing the method illustrated in FIG. 2. In another embodiment, the invention applies multiple file changes (e.g., from multiple patches) to the same file.

In one embodiment, the identified reference state of the file is independent of an original installation state (e.g., the RTM version) of the file. In another embodiment, the synthesis of the updated file involves the application of one or more file changes from several patches (one file change per patch) to the identified reference state.

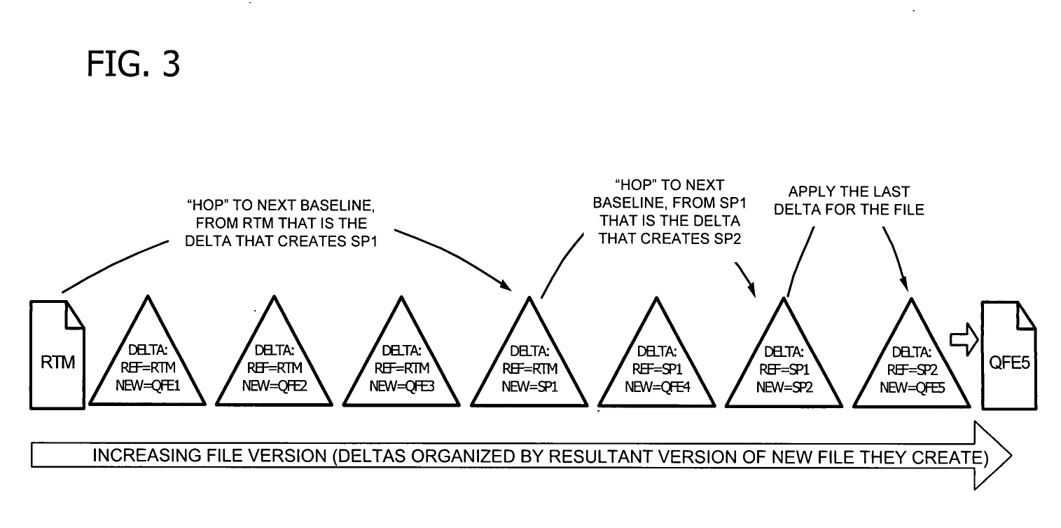

In general, an exemplary installation engine of the invention searches for a baseline stored in the baseline cache to which to apply the patch. The installation engine traverses from baseline to baseline ignoring intermediate QFEs. In particular, exemplary operation of the installation engine is illustrated in FIG. 3. In FIG. 3, a block diagram illustrates a baseline chain for synthesizing new files. The invention consolidates the declarative data from all currently installed patches, patches being applied, and patches being removed, and calculates on a per-file basis the baseline and updates required to synthesize the “new” file. The invention further modifies the actual machine state to put the product in compliance.

The installation engine or other embodiment of the invention tracks all baselines for a product by storing the status in a table in memory. The table indicates which baseline is active and which baseline(s) are being cached. Another table in memory maps patches to the files affected by the patches. With this table, the installation engine may enumerate a listing of all active patches that affected a single file.

In FIG. 3, the updates to be applied take the form of a delta or difference between the “new” file and the old file (e.g., reference file) as opposed to full-file updates. If the reference file is not available to the installation engine on the target computer, the invention fails. Updates comprised of these deltas are smaller than full-file updates. Binary delta compression technology is described in greater detail below. In the example of FIG. 3, the QFE5 version of the file is to be created based on the initial RTM version of the file. The installation engine applies a particular delta to the RTM version to create the next baseline version (e.g., SP1) of the file. The installation engine then applies another particular delta to the SP1 version to create the next baseline version (e.g., SP2) of the file. The installation engine then applies another particular delta to the SP2 version to create the QFE5 version of the file. Intermediate deltas that generate non-baseline versions (QFE1, QFE2, QFE3, and QFE4) are skipped. The chain begins with a baseline version of the file and continues with application of only those deltas that generate baselines. The last delta is then applied (which may or may not represent a baseline) to finally create the “new” file.

While FIG. 3 illustrates a forward approach to updating a file, heuristics are used to minimize the quantity of stored baselines and reduce patch application time. In one embodiment, the invention attempts to apply a patch to the most recent, cached baseline version of the file. The most recent baseline version of the file may be found in either the baseline cache, a full-file minor update patch, or in the target directory. For example, the installation engine would try to first patch a stored SP2 version of the file to create the QFE5 version. If the SP2 version is unavailable, the installation engine successively searches for the SP1 version, then searches for the RTM version, and then prompts the user to insert the original installation media to obtain the RTM version if necessary. The installation engine searches for the most recent baseline version, for example, as a function of a logical order associated with each baseline version. In one embodiment, the logical order corresponds to an install time or creation time of the baseline version. In another embodiment, the logical order of the versions has no correlation to the install or creation time of the versions. For example, even though Patch 1 may have been applied after Patch 2 temporally, Patch 1 and Patch 2 may be logically ordered such that the baseline version resulting from Patch 2 is more “recent” than the baseline version resulting from Patch 1. Alternatively or in addition, the installation engine may consult a lookup table, list, or other particular memory area to identify the most recent baseline version.

For example, the installation engine computes a checksum value for each of the files in the baseline cache. In one embodiment, files in the baseline cache are stored based upon a file table key. If a computed checksum value matches a checksum value for an update in the patch (e.g., in a header), the installation engine has located a baseline version in the cache and a corresponding update in the patch to apply thereto.

In one embodiment, the computed checksum value for each file is cached in the baseline cache to improve performance. In this manner, instead of having to recompute the checksum value every time the file in the cache is queried, a simple lookup in an index can be used to obtain the checksum value. Such an index saves a lot of time considering the expense incurred in computing the checksum (e.g., mapping the whole file into memory and then hashing it). In another embodiment, the checksum computation may be delayed during caching if the file was included as a full-file update. In this manner, the checksum computation cost only affects the patch that subsequently needs it.

In another exemplary embodiment of the invention, the installation engine may locate baseline versions of the file by querying commonly used file properties such as file version, file language, digital signature data, file manifest or other identifying attributes contained within or associated with the files. These attributes may also be cached to improve performance.

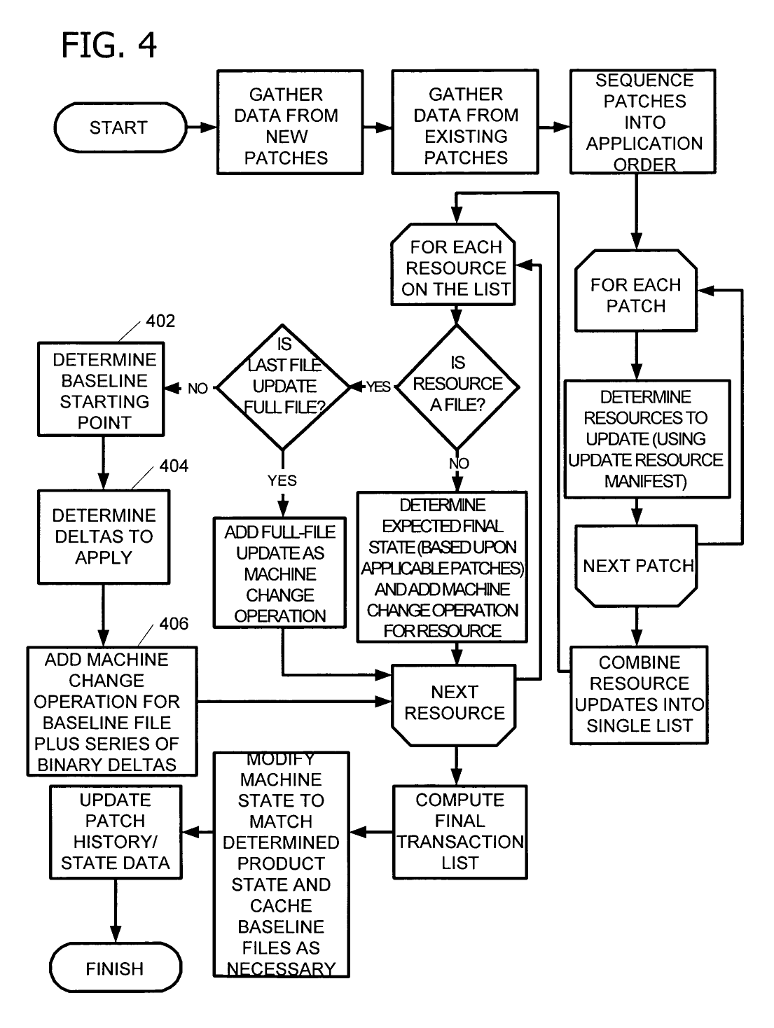

Referring next to FIG. 4, a flow chart illustrates operation of an exemplary installation engine. The flow control in FIG. 4 illustrates an exemplary context in which the invention operates. Determining the baseline starting point at 402, determining the deltas to apply at 404, and adding machine change operation for the baseline file plus a series of binary deltas at 406 reflect an exemplary embodiment of the invention. The other elements illustrated in FIG. 4 perform other functions associated with an exemplary patching solution.

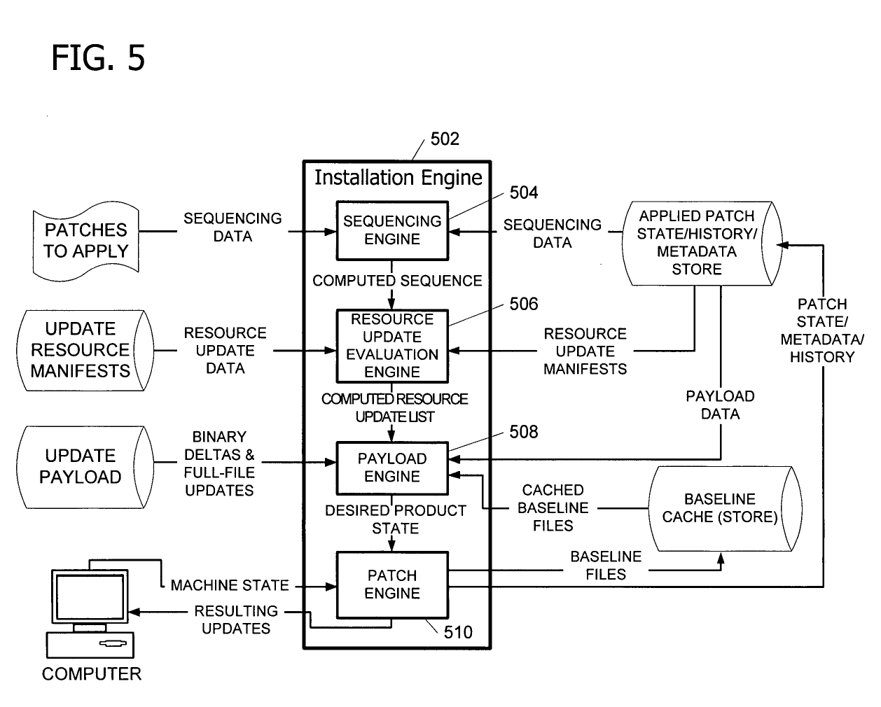

Referring next to FIG. 5, a block diagram illustrates an exemplary environment for the smart binary patching architecture of the invention. As shown in FIG. 5, a processor such as an installation engine 502 includes a sequencing engine 504, a resource update evaluation engine 506, a payload engine 508, and a patch engine 510. In FIG. 5, the installation engine 502 is attempting to apply a set of new patches to one or more software products installed on a patch target machine. Alternatively, installation engine 502 may attempt to simultaneously install the set of new patches and one or more software products to which patches are applicable to the patch target machine. The set of new patches represents one or more updates to one or more software products. As illustrated, the sequencing engine 504 of installation engine 502 receives the set of new patches. Included in this set of new patches is sequencing data that describes the logical order in which patches are to be applied to patch target machine. From a memory area such as a patch state\history store, sequencing engine 504 also receives sequencing data regarding patches already applied to patch target machine. By receiving the sequencing data of the new patches and the sequencing data of the patches already applied to patch target machine, sequencing engine 504 may identify those patches that are applicable to a software product that is installed or is to be installed on patch target machine. For example, sequencing engine 504 may determine that one or more of patches are obsoleted or superseded by an existing patch or have already been applied to the software product. Sequencing engine 504 may also return a final list of applicable patches.

Sequencing engine 504 further computes a logical order of an applicable patch relative to other applicable patches to be or already applied to patch target machine. For example, sequencing engine 504 may compute the logical order of application by determining a portion of the software product of which the applicable patches are members and then arranging the patches according to their relative orderings within the portion. Sequencing engine 504 then provides the computed patch sequence (i.e., the logical order of patches) of applicable patches to the resource update evaluation engine 506.

The resource update evaluation engine 506 receives the computed sequence from the sequencing engine 504, resource update data from update resource manifests, and resource update manifests from the applied patch state/history/metadata store. The resource update evaluation engine 506 generates a computed resource update list identifying the resources to be updated. The payload engine 508 receives the computed resource update list from the resource update evaluation engine 506, payload data from the applied patch state/history/metadata store, cached baseline files from the baseline cache, and binary deltas (e.g., representing a compressed difference between files) and full-file updates from the update payload. The payload engine 508 manages the file updates in each patch payload to determine the appropriate deltas to apply. The payload engine 508 outputs a desired product state. The patch engine 510 receives the desired product state from the payload engine 508 and the current machine state from the user's computer. Therefore, the patch engine 510 may determine how to apply the applicable patches to the user's computer as a function of the desired product state, the current machine state, and the computed patch sequence. The patch engine 510 applies the resulting updates to the user's computer according to the computed patch sequence such that patch target machine achieves the desired product state. The patch engine 510 also adds patch state/metadata/history to the applied patch state/history/metadata store. The applied patch state/history/metadata store may be referred to as, or included with, a configuration memory area which stores the current state of the file, among other data. If no reference file (baseline version of a file or original installation version of a file) is found in the cache or on disk, the user will be prompted for the original installation media.

In one embodiment, the patches are “sticky” in that even if the file being patched is not present on the target machine, the patch will be stored and later applied to the file when the file becomes available.

Directed Acyclic Graph (DAG)

In one specific implementation, if the invention fails to locate a desired baseline version (or a baseline version resulting from the patch that was applied last in a logical order of patches) of the file to which to apply the patch, the invention builds a directed acyclic graph (DAG) using predictive heuristics to identify the baseline to update and to determine the updates to apply to the identified baseline. In one embodiment, the edges of the DAG are unweighted (i.e. the edges all have the same cost) and the vertices are file checksums. The file checksum information is obtained from the patch header for the binary patch. The direction is from old file checksum to new file checksum. Active vertices are determined from existing available full files. An active vertex may be the file currently in the target location or one of the files in the baseline cache. A single-destination shortest paths algorithm is used to determine which binary patches for the file are required. There is only one destination (e.g., the target file checksum) but the starting vertices are multiple given the baseline cache files and existing files. If no shortest path result could be obtained, the invention resorts to prompting the user for access to the original installation media to obtain the original installation release of the file.

While creating a DAG is time-consuming, the invention optimizes the process by first attempting to use a limited DAG which includes the last binary patch plus the RTM and service packs. The limited DAG includes a graph built using the last binary patch in the sequence. A checksum value serves as the destination vertex. The possible source vertices come from the old checksum values. The remainder of the DAG is built by identifying a list of minor update patches. For each minor update patch, the patch header corresponding to the file being updated is queried and its information is added to the DAG. The checksum for the RTM file is also used as a possible source vertex. The direction and edges of the graph are determined based upon the old checksum values and the new checksum value. A single destination shortest path algorithm is used to determine which set of patches in the smallest number of hops from baseline to baseline is needed to update the file.

If the limited DAG does not yield the desired information, a complete DAG is built which contains vertices for all available information including QFEs, full files, and the file in the target location.

### ALTERNATIVE EMBODIMENTS

The method for creating and utilizing payload updates according to the invention may be employed by any servicing technology. This method is applicable to both static and dynamic payload designs, but will more commonly be appropriate to static payload distribution. In one embodiment, the invention is implemented without an installation engine. The update package format includes a means for bundling targeting information of the update with the payload. The targeting information and payload need not be contained within the same physical store. An engine or similar mechanism processes the targeting information and payload and organizes the delta updates in the appropriate order for application. The engine determines the appropriate checkpoint starting point on a per file basis and then synthesizes the new file using the checkpoint plus checkpoint deltas.

Binary Delta Compression

In one embodiment, a tool is provided that enables application vendors to create updates that utilize binary deltas as the patch payload. Conventional “self-contained” update packages (e.g., containing the entirety of all of the new files in compressed form) range from 500 kilobytes (KB) or less to several megabytes (MB), while service packs can be 100 MB or more. This makes download size a significant issue for customers with slow network connections. While the invention is operable with such update packages, the combination of the invention with other compression technologies is within the scope of the invention.

For example, binary delta compression is a technique for compressing files that differs from conventional techniques for compressing files. Conventional data compression techniques for file delivery use a compressor that accepts one file as input and produces a single compact version of that file as output. A decompressor performs the inverse function, accepting the compact form as input and reconstructing the original file for output on the destination computer.

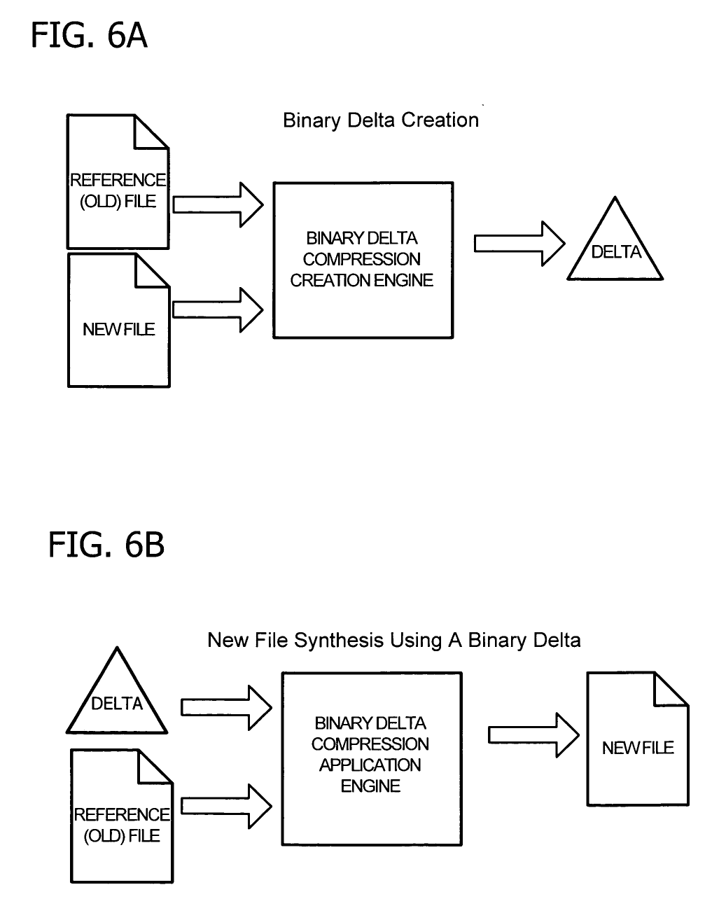

In contrast, for each file to be delivered, a binary delta compressor takes two files as input: the new file for delivery (F_{new}) and a reference file (F_{ref}) as shown in FIG. 6A. The reference file may be an older version of the new file. A binary delta compression creation engine (e.g., DeltaCreator) or other compressor determines the differences between the reference file and the new file and creates a compact “delta” or “difference” file (Delta_{F}) as output as shown in equation (1) below. While the delta file may be compressed or uncompressed, compressing the delta file provides an even greater reduction in size. On the destination computer, the binary delta compression application engine (e.g., DeltaApplicator) or other decompressor takes the existing reference file and the compact delta file as input and creates the new file as output as shown in FIG. 6B and equation (2) below.
DeltaCreator(F_{ref}, F_{new})→Delta_{F} (1)
DeltaApplicator(F_{ref, Delta}_{F})→F_{new} (2)

If the reference file and the new file are very similar, the size of the delta will be very small, generally much smaller than the file that results from simply compressing the new file conventionally. The size of the delta is proportional to the number of differences between the reference file and the new file. While a compression ratio for conventional compression of executable files might be approximately 3:1, the compression ratio for binary delta compression may be, for example, 10:1, 1,000:1, or even higher depending on the size of the original file and the number of differences. For example, if the code change is to fix a single buffer-overrun vulnerability, the delta may be as small as a few hundred bytes.

Because the reference file exists on the destination computer (e.g., a baseline version in the cache), only the compact delta file needs to be transmitted to the destination computer to construct the new file.

Exemplary Operating Environment

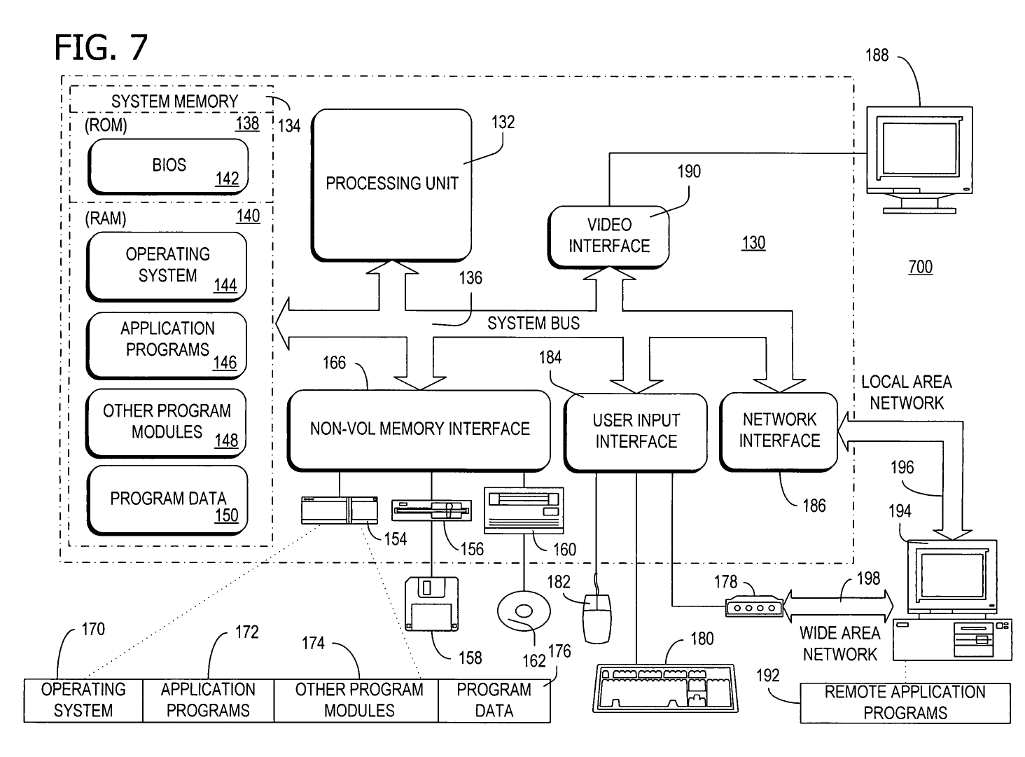

FIG. 7 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 7 illustrates operating system 144, application programs 146, other program modules 148, and program data 150.

The computer 130 may also include other removable/non-removable, volatile/nonvolatile computer storage media. For example, FIG. 7 illustrates a hard disk drive 154 that reads from or writes to non-removable, nonvolatile magnetic media. FIG. 7 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 7, provide storage of computer readable instructions, data structures, program modules and other data for the computer 130. In FIG. 7, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 7 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 7 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions such as those illustrated in FIG. 2 to apply a patch to a file associated with a computing device.

The following examples further illustrate the invention. In one example of the operation of the patching solution of the invention, a file example.dll has several possible configurations. In particular, the following updates have been disseminated for example.dll in this order: QFE1, SP1, QFE2, SP2, QFE3, SP3, QFE4, SP4, and QFE5. The SPs represent baseline versions. In this example, all of the patches except QFE5 have been applied to the product associated with example.dll making SP4 the current state of the file. The SP4 version of the file is stored in the target directory. Further for this example, the copy-on-write cache policy is to store the last baseline and the RTM version in the cache (or elsewhere on the user's computer), resulting in the storage on the user's computer of the RTM version in the cache and the SP4 version of the file in the target directory. As each patch targets the last two baselines in this example, the binary patch QFE5 targets SP3 and SP4. After QFE5 is applied, the SP4 version of the file is added to the baseline cache. As a result, three versions of the file exist on the user's computer: RTM in the cache, SP4 in the cache, and QFE5 in the target directory.

If the last patch applied to the file were QFE4, the installation engine would know that the SP3 version of the file is located in the cache. However, in this example, because the last patch applied to the file was SP4, the installation engine knows that the SP4 version of the file may be found in the target directory. The installation engine looks at the checksum (e.g., a cyclic redundancy check) for the file in the target directory. The checksum values are computed by the installation engine or pre-computed and stored in an index file to reduce patching time. Upon finding the SP4 version, the installation engine applies QFE5 to the SP4 version because the patch includes an update targeted to the SP4 version.

If the SP4 version of the file is missing, the installation engine will search the baseline cache and other applied minor update (baseline) patches for a baseline reference file in order to formulate a baseline chain of updates for the file. In this scenario, all applied patches used binary deltas; therefore the only possible sources for a reference baseline file are the RTM version in the RTM baseline cache and the RTM version on the original installation source media. The installation engine finds the RTM baseline file and uses that as the reference file starting point. Subsequent baseline deltas are applied (+SP1, +SP2, +SP3, and +SP4) and then the final delta is applied (+QFE5).

In another embodiment of the invention for the same scenario, the installation engine is unable to find either SP3 or SP4 in the target directory or the cache, so the installation engine builds a DAG. In one embodiment, a limited DAG for this example has vertices of RTM, SP1, SP2, SP3, SP4, and QFE5. Edges connect the following vertices:

RTM→SP1

RTM→SP2

SP1→SP2

SP1→SP3

SP2→SP3

SP2→SP4

SP3→SP4

SP3→QFE5

SP4→QFE5

A single destination shortest path algorithm finds the shortest patch which comprises three hops. Any one of the following routes is possible:

RTM→SP2→SP4→QFE5

RTM→SP1→SP3→QFE5

RTM→SP2 SP3→QFE5

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A method for applying a patch to a file on a computing device, said method comprising:
receiving a patch, said patch having one or more file changes;
determining, from the received patch, a file on a computing device to be changed by the received patch;
identifying a current state of the determined file on the computing device, said identified current state representing a reference state with at least one other file change applied thereto;
identifying the reference state of the file from the identified current state;
selecting one of the one or more file changes from the received patch as a function of the identified reference state, said selected file change corresponding to the identified reference state; and
applying the selected file change to the identified reference state to change the file.

2. The method of claim 1, wherein receiving the patch comprises receiving the patch with each of the one or more changes as a binary delta file, said binary delta file representing a difference between the file to be changed and a changed file.

3. The method of claim 2, wherein the binary delta file is compressed.

4. The method of claim 1, wherein the file relates to a product, and wherein identifying the reference state comprises identifying a baseline version of the product.

5. The method of claim 1, wherein the identified current state comprises a plurality of reference states and file changes applied thereto, and wherein identifying the reference state of the file from the identified current state comprises selecting one of the plurality of reference states.

6. The method of claim 1, further comprising retrieving the identified reference state of the file from a cache.

7. The method of claim 6, wherein retrieving the identified reference state of the file from the cache comprises generating the identified reference state from one or more of the following: a plurality of other cached states of the file, cached binary-delta data, and data from other patches.

8. The method of claim 1, wherein the identified reference state of the file is independent of an original installation state of the file.

9. The method of claim 1, wherein a configuration memory area stores the current state of the file, and further comprising updating the configuration memory area in response to applying the selected file change to the identified reference state.

10. The method of claim 1, further comprising:
determining if the current state of the file prior to applying the selected file change is stored in a cache; and
updating the cache as a function of said determining if the current state of the file prior to applying the selected file change is stored in a cache.

11. The method of claim 10, wherein updating the cache comprises storing the current state of the file in the cache.

12. The method of claim 11, wherein storing the current state of the file in the cache comprises storing the differences between the current state and another state of the file stored in the cache.

13. The method of claim 11, wherein storing the current state of the file in the cache comprises storing the differences between the current state and an updated state.

14. The method of claim 1, further comprising storing the reference state on the computing device.

15. The method of claim 1, wherein receiving the patch comprises receiving the patch from a patch server.

16. The method of claim 1, further comprising:
receiving another patch for the file, said other patch having one or more other file changes;
selecting one of the one or more other file changes from the other patch as a function of the identified reference state, said selected other file change corresponding to the identified reference state; and
applying the selected other file change to the identified reference state to change the file.

17. The method of claim 1, wherein the identified reference state represents another reference state with at least one other file change applied thereto, and further comprising:
identifying the other reference state of the file from the identified reference state;
selecting another one of the one or more file changes from the received patch as a function of the identified other reference state, said selected other file change corresponding to the identified other reference state; and
applying the selected other file change to the identified other reference state to change the file.

18. The method of claim 17, wherein applying the selected other file change comprises applying the selected other file change to the identified other reference state to create the identified reference state of the file.

19. The method of claim 1, wherein one or more computer-readable media have computer-executable instructions for performing the method recited in claim 1.

20. A method for applying a patch to a file on a computing device, said patch including one or more updates to the file, said method comprising:
storing a current version of the file and a plurality of prior versions of the file, said plurality of prior versions having a logical order relative to each other and to the current version, said one or more updates each corresponding to one of the stored prior versions of the file;
identifying, as a function of the logical order of the plurality of prior versions, one of the stored prior versions of the file to be updated; and
selecting one of the updates to apply to the file, said selected one of the updates corresponding to the identified prior version;
applying the selected update to the identified prior version of the file.

21. The method of claim 20, wherein each of the one or more updates represent a difference between the file to be updated and an updated file.

22. The method of claim 20, wherein the one or more updates are compressed.

23. The method of claim 20, wherein the identified prior version of the file is independent of an original installation state of the file.

24. The method of claim 20, wherein one or more computer-readable media have computer-executable instructions for performing the method recited in claim 20.

25. A method of providing a patch to create a new version of a file, said method comprising:
defining a file to have a plurality of primary versions and one or more secondary versions;
identifying each of the plurality of primary versions;
generating a plurality of updates, each of the generated plurality of updates to apply to each of the identified primary versions resulting in a new version of the file;
aggregating the generated updates to create a patch for the file; and
providing the created patch to an end user.

26. The method of claim 25, further comprising for each of the identified primary versions, computing a difference between the identified primary version and the new version of the file.

27. The method of claim 25, further comprising compressing the computed difference for each of the identified primary versions.

28. The method of claim 25, further comprising identifying the created patch as a baseline version of the file.

29. The method of claim 25, wherein one or more computer-readable media have computer-executable instructions for performing the method of claim 25.

30. One or more computer-readable media having computer-executable components for applying a patch to a file on a computing device, said components comprising:
a sequencing engine for receiving a patch, said patch having one or more file changes;
a resource update evaluation engine for determining, from the received patch, a file on a computing device to be changed by the received patch, said resource update evaluation engine further identifying a current state of the determined file on the computing device, said identified current state representing a reference state with at least one other file change applied thereto, said resource update evaluation engine further identifying the reference state of the file from the identified current state;
a payload engine for selecting one of the one or more file changes from the received patch as a function of the identified reference state, said selected file change corresponding to the identified reference state; and
a patch engine for applying the selected file change to the identified reference state to change the file.

31. The computer-readable media of claim 30, wherein receiving the patch comprises receiving the patch having each of the one or more changes as a binary delta file, said binary delta file representing a difference between the file to be changed and a changed file.

32. The computer-readable media of claim 30, wherein the binary delta file is compressed.

33. The computer-readable media of claim 30, wherein the identified current state comprises a plurality of reference states and file changes applied thereto, and wherein identifying the reference state of the file from the identified current state comprises selecting one of the plurality of reference states.

34. The computer-readable media of claim 30, further comprising retrieving the identified reference state of the file from a cache.

35. The computer-readable media of claim 30, wherein the identified reference state of the file is independent of an original installation state of the file.

36. A system for applying a patch, said system comprising:
a memory area storing a current state of a file and a reference state of the file having file changes applied thereto, said memory area further storing a patch, said patch comprising one or more patch changes; and
a processor configured to execute computer-executable instructions for:
determining, from the patch stored in the memory area, the file to be changed by the patch stored in the memory area;
selecting one of the one or more patch changes from the stored patch as a function of the reference state stored in the memory area, said selected patch change corresponding to the reference state stored in the memory area; and
applying the selected patch change to the stored reference state to change the file.

37. The system of claim 36, wherein each of the patch changes comprises a binary delta file representing a difference between the file to be changed and an changed file.

38. The system of claim 36, wherein the binary delta file is compressed.

39. The system of claim 36, wherein the reference state of the file is independent of an original installation state of the file.

40. The system of claim 36, wherein the file relates to a product, and wherein the reference state of the file represents a baseline version of the product.
